(19) United States
(12) Patent Application Publication
(10) Pub. No.: US 2015/0286890 A1
(43) Pub. Date: Oct. 8, 2015

(54) Devices and Methods for Image Processing

(71) Applicant: Tencent Technology (Shenzhen) Company Limited, Shenzhen (CN)

(72) Inventor: Baolong Yang, Shenzhen (CN)

(21) Appl. No.: 14/745,833

(22) Filed: Jun. 22, 2015

Related U.S. Application Data
(63) Continuation of application No. PCT/CN2014/082202, filed on Jul. 15, 2014.

(30) Foreign Application Priority Data
Jul. 24, 2013 (CN) 201310313816.5

(51) Int. Cl. G06K 9/46; G06T 5/20; G06T 5/00

(52) U.S. Cl. CPC G06K 9/46; G06T 5/005; G06T 5/20; G06T 2207/10004; G06T 2207/20004; G06T 2207/20172; G06T 2207/20092

(57) ABSTRACT

Devices and methods are provided for image processing. For example, an image to be processed is opened; the image is analyzed to obtain one or more feature attributes of the image; image processing data is obtained based on at least information associated with the feature attributes; the image is processed based on at least information associated with the image processing data; and the processed image is displayed.

### CROSS-REFERENCES TO RELATED APPLICATIONS

The application claims priority to Chinese Patent Application No. 201310313816.5, filed Jul. 24, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to image processing. But it would be recognized that the invention has a much broader range of applicability.

Image beautification applications become popular, and more people employ image beautification applications to process photos to obtain images with more desirable effects. Currently, a user may use two approaches for beautification of images. For example, an image processing with user-defined parameters offers interfaces of parameters, such as maturity, color temperature, and contrast, to a user, and allows the user to adjust various image parameters according to desirable image effects. Another approach corresponds to customized filter processing which provides various image processing templates, and the user is allowed to select different image processing templates based on the images to be processed, so as to obtain different image styles.

The above-noted conventional technology has some disadvantages. For example, a user is allowed to merely adjust different parameters in sequence or employ different image processing templates, which results in complicated operations, waste of time, and poor image effects.

Hence it is highly desirable to improve the techniques for image processing.

### BRIEF SUMMARY OF THE INVENTION

According to one embodiment, a method is provided for image processing. For example, an image to be processed is opened; the image is analyzed to obtain one or more feature attributes of the image; image processing data is obtained based on at least information associated with the feature attributes; the image is processed based on at least information associated with the image processing data; and the processed image is displayed.

According to another embodiment, an image processing device includes: an opening unit configured to open an image to be processed; an analysis unit configured to analyze the image to obtain one or more feature attributes of the image; an acquisition unit configured to obtain image processing data based on at least information associated with the feature attributes; a processing unit configured to process the image based on at least information associated with the image processing data; and a displaying unit configured to display the processed image.

According to yet another embodiment, a non-transitory computer readable storage medium includes programming instructions for image processing. The programming instructions are configured to cause one or more data processors to execute certain operations. For example, an image to be processed is opened; the image is analyzed to obtain one or more feature attributes of the image; image processing data is obtained based on at least information associated with the feature attributes; the image is processed based on at least information associated with the image processing data; and the processed image is displayed.

For example, the systems and methods disclosed herein are configured to analyze feature attributes of an image and process the image according to the feature attributes so as to simplify operations, save time for image processing and obtain desirable image effects.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for image processing according to one embodiment of the present invention.

FIG. 2 is a simplified diagram showing a method for image processing according to another embodiment of the present invention.

FIG. 3 is a simplified diagram showing a device for image processing according to one embodiment of the present invention.

FIG. 4 is a simplified diagram showing a device for image processing according to another embodiment of the present invention.

### DETAILED DESCRIPTION OF THE INVENTION

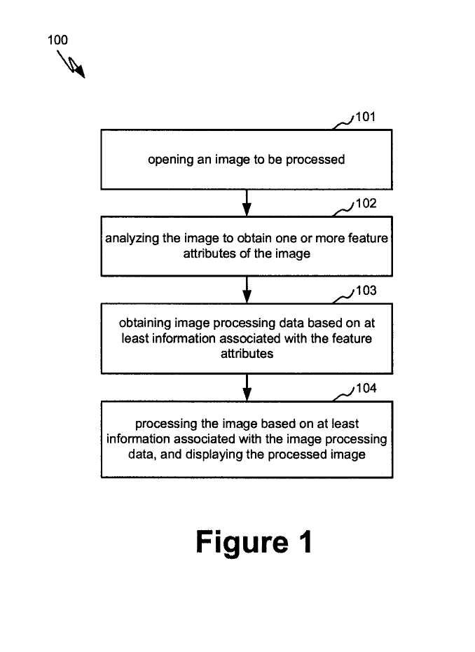

FIG. 1 is a simplified diagram showing a method for image processing according to one embodiment of the present invention. The diagram is merely an example, which should not unduly limit the scope of the claims. One of ordinary skill in the art would recognize many variations, alternatives, and modifications. The method 100 includes at least processes 101-104.

According to one embodiment, the method 100 is executed by a terminal. For example, the terminal includes a smart phone, a tablet computer, a notebook computer, etc. As an example, the method is executed using an image processing application on the terminal.

According to another embodiment, the process 101 includes: opening an image to be processed. For example, the image processing application on the terminal receives an instruction from a user to open the image to be processed, and opens the image to be processed according to the instruction. As an example, the image to be processed can be an image saved on a storage device of a terminal. In another example, the image to be processed can be a self-portrait image, a scenery image, an animal image, etc.

According to yet another embodiment, the process 102 includes: analyzing the image to be processed, and obtaining one or more feature attributes of the image to be processed. For example, the image processing application on the terminal analyzes the image content, the image style, and/or the expression of people of the image to be processed. As an example, the image content includes a picture displayed in the image. As another example, the image content includes a portrait image, a scenery image, an animal image, etc. As yet another example, the image style includes an overall color tone displayed in the image. For example, if a photo is taken in a dimly-lit location, such as a bar, then the displayed color tone in the image corresponds to a cold color tone. In another example, if a photo is taken on a sunny beach, then the displayed color tone in the image corresponds to a warm color tone. In yet another example, the expression of people includes a grim expression, a joyful expression, etc.

In one embodiment, after the image content, the image style, and/or the expression of the people in the image are analyzed, and one or more feature attributes of the image to be processed are obtained. For example, the feature attributes are obtained from the analysis of the image to be processed, and include an image type attribute, an exposure attribute, a gender attribute, an expression attribute, etc. In another example, the image type attribute includes a portrait type or a scenery type. In yet another example, the gender attribute includes male and female. In yet another example, the expression attribute includes grim, joyful, etc.

In another embodiment, various interfaces such as YouTu, Vision Open Statistical Models (VOSM), and image content subject identification, may be implemented to analyze the image content, the portrait expression, etc. For example, YouTu is an application for portrait processing. In another example, VOSM that includes a human face fitting library based on the open source technology can detect profiles of human faces and locations and shapes of important features, such as mouth corners, eyes, and noses.

The process 102 is executed on a server, according to certain embodiments. For example, the image to be processed is sent to the server, and the server analyzes the image content, the image style, the expression of people in the image, etc., so as to obtain the feature attributes of the image to be processed.

In yet another embodiment, the process 103 includes: obtaining image processing data according to the feature attributes. For example, the process 103 is executed on a terminal. In another example, the process 103 is executed on a server, and the server obtains at least one type of the image processing data according to the feature attributes. In yet another example, each type of image processing data corresponds to an image processing template.

According to one embodiment, the process 104 includes: processing the image to be processed according to the image processing data, and displaying the image after processing. For example, the processing of the image to be processed according to the image processing data includes: applying (e.g., in sequence) one or more image processing templates corresponding to the image processing data to the image to be processed.

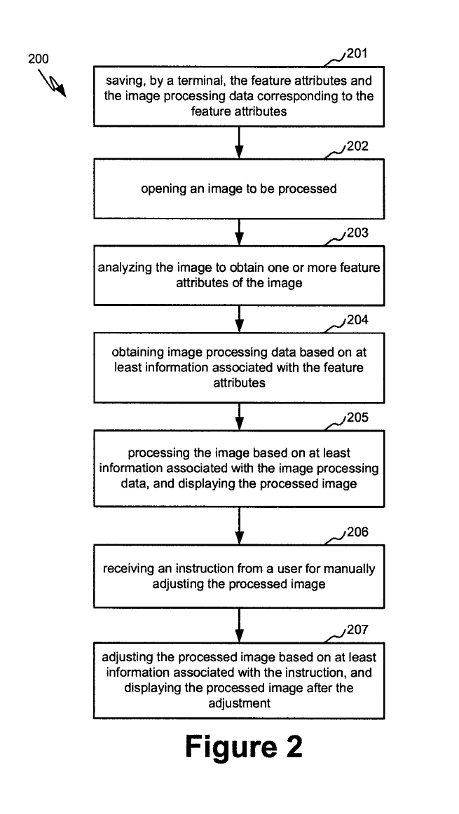

FIG. 2 is a simplified diagram showing a method for image processing according to another embodiment of the present invention. The diagram is merely an example, which should not unduly limit the scope of the claims. One of ordinary skill in the art would recognize many variations, alternatives, and modifications. The method 200 includes at least processes 201-207.

According to one embodiment, during the process 201, a terminal saves one or more feature attributes and image processing data corresponding to the feature attributes. For example, the feature attributes are obtained after an image processing application on the terminal analyzes the image to be processed. As an example, the feature attributes include one or more of the following: an image type attribute, an exposure attribute, a gender attribute, an expression attribute, etc. As another example, the image type includes a portrait type or a scenery type. As yet another example, each type of the image processing data corresponds to one or more feature attributes. As yet another example, the image processing data is used to process an image, where the processed image is in accordance with the feature attributes. The feature attributes and the image processing data corresponding to the feature attributes can be saved in a terminal in advance, according to certain embodiments. For example, during subsequent image processing, the image processing data corresponding to the feature attributes can be directly obtained for further processing of the image. The feature attributes and the image processing data corresponding to the feature attributes are saved on a server, so that the server can process the image, according to some embodiments.

According to another embodiment, the process 202 includes: opening an image to be processed. For example, the image processing application on the terminal receives an instruction from a user to open the image to be processed, and opens the image to be processed according to the instruction. As an example, the image to be processed can be an image saved on a storage device of a terminal. In another example, the image to be processed can be a self-portrait image, a scenery image, an animal image, etc.

According to yet another embodiment, the process 203 includes: analyzing the image to be processed, and obtaining one or more feature attributes of the image to be processed. For example, the image processing application on the terminal analyzes the image content, the image style, and/or the expression of people of the image to be processed, so as to obtain the feature attributes of the image to be processed. As an example, the feature attributes include an image type attribute, an exposure attribute, a gender attribute, an expression attribute, etc. In another example, the image type attribute includes a portrait type or a scenery type. The process 203 is the same as the process 102 as shown in FIG. 1, according to some embodiments. For example, an image to be processed includes a photo showing a girl who laughs aloud on a meadow under the sun. After an image processing application on a terminal analyzes the opened image to be processed, feature attributes, including a gender attribute and an expression attribute, are obtained. The gender is female and the expression is a joyful expression. In another example, an image to be processed includes a photo of a girl in a bar with dim lighting. After an image processing application in a terminal analyzes the opened image to be processed, the feature attributes, including a gender attribute and an expression attribute, are obtained. The gender is female and the expression is a grim expression.

In one embodiment, when an image to be processed includes a scenery image or an animal image, after an image processing application in a terminal analyzes the opened image to be processed, the feature attributes, e.g., an image type attribute, are obtained. For example the image type is nature scenery.

In another embodiment, the process 204 includes: image processing data is obtained according to the feature attributes. For example, according to the obtained feature attributes, the terminal queries pre-stored feature attributes and pre-stored image processing data associated with the pre-stored feature attributes on the terminal, and then obtains image processing data corresponding to the obtained feature attributes. As an example, the obtained feature attributes include a gender attribute and an expression attribute, where the gender attribute includes female, and the expression attribute includes a joyful expression. Then the image processing data corresponding to female and the image processing data corresponding to the joyful expression are obtained. In some embodiments, the image processing data corresponding to the female gender attribute are used for performing beautification processing of the portrait on the image. In certain embodiments, the image processing data corresponding to the joyful expression attribute are used for performing warm color tone processing on the image. In some embodiments, the image processing data corresponding to each feature attribute can be used for performing various different processing on different aspects of the image.

In yet another embodiment, the process 205 includes: processing the image to be processed according to the image processing data, and displaying the image after processing. For example, the processing of the image to be processed according to the image processing data includes: applying (e.g., in sequence) one or more image processing templates corresponding to the image processing data to the image to be processed. As an example, when the beautification processing is performed on the portrait of the image to be processed according to the image processing data corresponding to a female gender attribute, the beautification processing includes whitening processing on the skin in the portrait, removal of spots on the face in the portrait, etc. As another example, when a warm color tone processing is performed on the image to be processed according to the image processing data corresponding to a joyful expression attribute, the color tone of the image to be processed is adjusted to warm, so as to match the image closer to an original photo and obtain better image effects. A user has a most appropriate beautification processing module for processing the image without trying different filters in sequence and adjusts various parameters, so that the user experience is vastly improved, according to some embodiments.

According to one embodiment, the process 206 includes: receiving an instruction from a user for manually adjusting the processed image. For example, when the user views the image effects after the beautification processing and discovers that the effects of the image fail the user's expectation, the user is able to manually adjust the image with other special effect filters or to adjust user-defined parameters. As an example, the terminal receives instructions from the user to manually adjust the image with other special effect filters or to adjust the user-defined parameters.

According to another embodiment, the process 207 includes: adjusting the processed image based on at least information associated with the instruction and displaying the processed image after the adjustment. For example, if the image after the adjustment still does not satisfy the user, the user is able to continue to adjust manually.

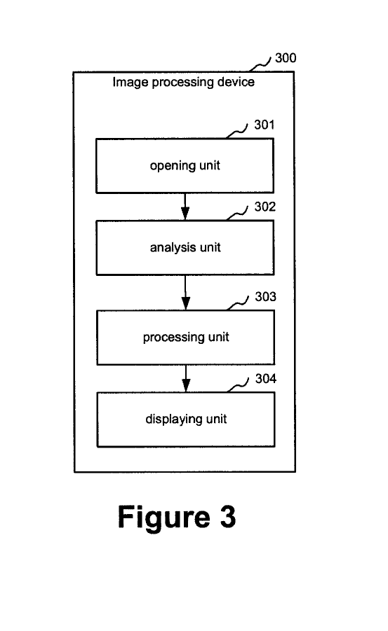

FIG. 3 is a simplified diagram showing a device for image processing according to one embodiment of the present invention. The diagram is merely an example, which should not unduly limit the scope of the claims. One of ordinary skill in the art would recognize many variations, alternatives, and modifications. The device 300 includes an opening unit 301, an analysis unit 302, an acquisition unit 303, a processing unit 304, and a displaying unit 305.

According to one embodiment, the opening unit 301 is configured to open an image to be processed. For example, the opening unit 301 receives an instruction from a user to open the image to be processed, and opens the image to be processed according to the instruction. As an example, the image to be processed can be an image saved on a storage device of a terminal. In another example, the image to be processed can be a self-portrait image, a scenery image, an animal image, etc.

According to another embodiment, the analysis unit 302 is configured to analyze the image to be processed and obtain one or more feature attributes of the image to be processed. For example, the analysis unit 302 analyzes the image content, the image style, and/or the expression of people of the image to be processed. As an example, the image content includes a picture displayed in the image. As another example, the image content includes a portrait image, a scenery image, an animal image, etc. As yet another example, the image style includes an overall color tone displayed in the image. For example, if a photo is taken in a dimly-lit location, such as a bar, then the displayed color tone in the image corresponds to a cold color tone. In another example, if a photo is taken on a sunny beach, then the displayed color tone in the image corresponds to a warm color tone. In yet another example, the expression of people includes a grim expression, a joyful expression, etc. In yet another example, the feature attributes include an image type attribute, an exposure attribute, a gender attribute, an expression attribute, etc. In another example, the image type attribute includes a portrait type or a scenery type.

According to yet another embodiment, the acquisition unit 303 is configured to obtain image processing data according to the feature attributes. For example, the processing unit 304 is configured to process the image to be processed according to the image processing data. In another example, at least one feature attribute is obtained after the image to be processed is analyzed, and accordingly at least one type of corresponding image processing data is obtained. In yet another example, each type of image processing data corresponds to an image processing template. In yet another example, the processing unit 304 is configured to: apply at least one image processing template corresponding to the image processing data to the image to be processed in sequence. In yet another example, the displaying unit 305 is configured to display the image after processing. The device 300 is configured to execute the method 100, according to some embodiments.

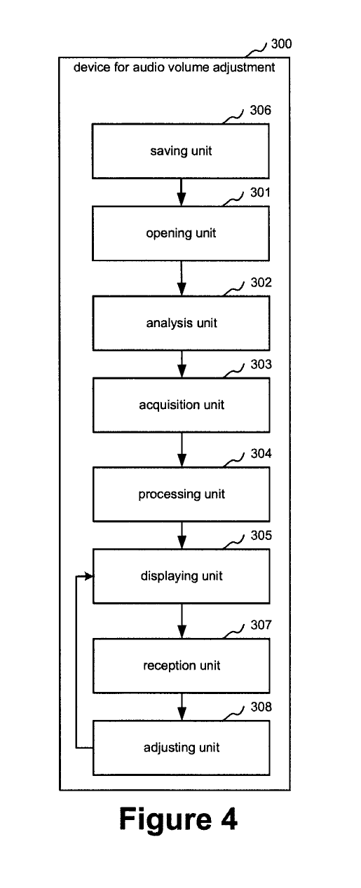

FIG. 4 is a simplified diagram showing a device for image processing according to another embodiment of the present invention. The diagram is merely an example, which should not unduly limit the scope of the claims. One of ordinary skill in the art would recognize many variations, alternatives, and modifications. The device 300 further includes a saving unit 306, a reception unit 307, and an adjusting unit 308.

According to one embodiment, before the opening unit 301 opens the image to be processed, the saving unit 306 is configured to save the feature attributes and the image processing data corresponding to the feature attributes, and the image processing data can be utilized for processing the image afterwards. As an example, the processing unit 304 is configured to analyze the image to be processed according to the image processing data. As another example, the displaying unit 305 displays the processed image. For example, when the user reviews the processed image, and finds out that the image effects fail the user expectations, the reception unit 307 is configured to receive an instruction from the user for manually adjusting the processed image. In another example, the adjusting unit 308 is configured to adjust the processed image according to the instruction, and the displaying unit 305 is further configured to display the processed image after readjustment. The device 400 is configured to execute the method 200, according to some embodiments.

According to another embodiment, a method is provided for image processing. For example, an image to be processed is opened; the image is analyzed to obtain one or more feature attributes of the image; image processing data is obtained based on at least information associated with the feature attributes; the image is processed based on at least information associated with the image processing data; and the processed image is displayed. For example, the method is implemented according to at least FIG. 1 and/or FIG. 2.

According to another embodiment, an image processing device includes: an opening unit configured to open an image to be processed; an analysis unit configured to analyze the image to obtain one or more feature attributes of the image; an acquisition unit configured to obtain image processing data based on at least information associated with the feature attributes; a processing unit configured to process the image based on at least information associated with the image processing data; and a displaying unit configured to display the processed image. For example, the device is implemented according to at least FIG. 3 and/or FIG. 4.

According to yet another embodiment, a non-transitory computer readable storage medium includes programming instructions for image processing. The programming instructions are configured to cause one or more data processors to execute certain operations. For example, an image to be processed is opened; the image is analyzed to obtain one or more feature attributes of the image; image processing data is obtained based on at least information associated with the feature attributes; the image is processed based on at least information associated with the image processing data; and the processed image is displayed. For example, the storage medium is implemented according to at least FIG. 1 and/or FIG. 2.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A method for image processing comprising:
opening an image to be processed;
analyzing the image to obtain one or more feature attributes of the image;
obtaining image processing data based on at least information associated with the feature attributes;
processing the image based on at least information associated with the image processing data; and
displaying the processed image.

2. The method of claim 1, wherein the analyzing the image to obtain one or more feature attributes of the image includes:
analyzing image content, image style, or expression of people associated with the image to obtain the feature attributes.

3. The method of claim 1, wherein:
the feature attributes include one or more of the following: an image type attribute, an exposure attribute, a gender attribute, and an expression attribute; and
the image type attribute includes a portrait type or a scenery type.

4. The method of claim 3, wherein:
the image processing data corresponds to one or more image processing templates;
the processing the image based on at least information associated with the image processing data includes:
applying the one or more image processing templates corresponding to the image processing data to the image.

5. The method of claim 1, further comprising:
saving the feature attributes and the image processing data corresponding to the feature attributes.

6. The method of claim 1, further comprising:
receiving an instruction from a user for manually adjusting the processed image;
adjusting the processed image based on at least information associated with the instruction; and
displaying the processed image after the adjustment.

7. An image processing device comprising:
an opening unit configured to open an image to be processed;
an analysis unit configured to analyze the image to obtain one or more feature attributes of the image;
an acquisition unit configured to obtain image processing data based on at least information associated with the feature attributes;
a processing unit configured to process the image based on at least information associated with the image processing data; and
a displaying unit configured to display the processed image.

8. The device of claim 7, wherein the analysis unit is configured to:
analyze image content, image style, or expression of people associated with the image to obtain the feature attributes.

9. The device of claim 7, wherein,
the feature attributes include one or more of the following: an image type attribute, an exposure attribute, a gender attribute, and an expression attribute; and
the image type attribute includes a portrait type or a scenery type.

10. The device of claim 9, wherein:
the image processing data corresponds to one or more image processing templates;
the processing unit is configured to:
the one or more image processing templates corresponding to the image processing data to the image.

11. The device of claim 7, further comprising:
a saving unit configured to save the feature attributes and the image processing data corresponding to the feature attributes.

12. The device of claim 7, further comprising:
a reception unit configured to receive an instruction from a user for manually adjusting the processed image; and
an adjusting unit configured to adjust the processed image based on at least information associated with the instruction;
wherein the displaying unit is further configured to display the processed image after the adjustment.

13. The device of claim 7, further comprising:
one or more data processors; and
a computer-readable storage medium;
wherein one or more of the opening unit, the opening unit, the acquisition unit, the processing unit and the displaying unit are stored in the storage medium and configured to be executed by the one or more data processors.

14. A non-transitory computer readable storage medium comprising programming instructions for image processing, the programming instructions configured to cause one or more data processors to execute operations comprising:
opening an image to be processed;
analyzing the image to obtain one or more feature attributes of the image;
obtaining image processing data based on at least information associated with the feature attributes;
processing the image based on at least information associated with the image processing data; and
displaying the processed image.
